(19) United States
(12) Patent Application Publication
(10) Pub. No.: US 2018/0047497 A1
(43) Pub. Date: Feb. 15, 2018

(54) NOISE FILTER

(71) Applicant: Mitsubishi Electric Corporation, Chiyoda-ku (JP)

(72) Inventors: Naruto MIYAKAWA, Chiyoda-ku (JP); Kenichi SUGA, Chiyoda-ku (JP); Ken HIRAKIDA, Chiyoda-ku (JP); Kenji SHIMOHATA, Chiyoda-ku (JP); Nobuyuki HARUNA, Chiyoda-ku (JP); Keita TAKAHASHI, Chiyoda-ku (JP)

(73) Assignee: Mitsubishi Electric Corporation, Chiyoda-ku (JP)

(21) Appl. No.: 15/554,865

(22) PCT Filed: Jan. 22, 2016
(86) PCT No.: PCT/JP2016/051875

§ 371 Date: Aug. 31, 2017

(30) Foreign Application Priority Data
Apr. 8, 2015 (JP) 2015-079268

(51) Int. Cl. H01F 27/28; H01F 17/06; H01F 27/24

(52) U.S. Cl. CPC H01F 27/2876; H01F 27/24; H01F 17/06; H01F 2017/0093

(57) ABSTRACT

A noise filter (100, 200, 300) provided with: a coil (1a, 1b) having a winding pattern configured by stacking flat plate-shaped conductors (50); a magnetic core (2) around which the coil (1a, 1b) is wound; and a heat dissipation member (3) electrically insulated from and closely attached to an end of the coil (1a, 1b) in a stacking direction, wherein a thermal resistance of one of the conductors (50), disposed at the end in the stacking direction of the coil (1a, 1b), is the lowest compared with the thermal resistances of the other conductors (50).

### TECHNICAL FIELD

The present invention relates to a noise filter installed in power converters or the like.

### BACKGROUND ART

Some power converters are equipped with a noise filter in order that the noise generated by a switching operation of a semiconductor device is prevented from leaking outside. Generally, such a noise filter is composed of a coil and a magnetic core. If a large current flows in the coil, the magnetic properties of the magnetic core deteriorate because of the coil heat generation, which may lead to deterioration of properties as the noise filter.

To cope with this, the noise filter needs to be cooled.

A technique in traditional noise filters is disclosed in which the coil is disposed in a space surrounded by heat dissipating fins in order to cool the noise filter (for example, refer to Patent Document 1).

### PRIOR ART DOCUMENT

### Patent Document

Patent Document 1: International publication No: 2012/090307 (page 8, FIG. 1)

### SUMMARY OF THE INVENTION

### Problems to be Solved by the Invention

In a traditional noise filter, the coil's outer face facing the heat dissipating fins is cooled down, but the temperature around the coil center rises because heat tends to build up around the coil center. As the result, the temperature of the magnetic core around the coil center rises, which may deteriorate properties of the noise filter. In order to suppress the temperature rise around the coil center, the sectional area of the coil may be enlarged to lower the density of the current flowing in the coil, but this method leads to an upsized noise filter.

The present invention is made to solve the problems described above and aims to improve the heat dissipation of a noise filter without upsizing the filter itself.

### Means for Solving the Problems

A noise filter according to the present invention includes: a coil having a winding pattern configured by stacking flat plate-shaped conductors; a magnetic core around which the coil is wound; and a heat dissipation member electrically insulated from and closely attached to an end of the coil in a stacking direction, wherein a thermal resistance of one of the conductors, disposed at the end in the coil stacking direction, is the lowest compared with thermal resistances of the other conductors.

### Effect of the Invention

According to the present invention, because the conductor that is disposed at an end in the stacking direction, and closely attached to the heat dissipation member is made to have a thermal resistance lower than thermal resistances of the other conductors, the heat dissipation of the noise filter can be improved without upsizing itself.

### BRIEF DESCRIPTION OF DRAWINGS

FIG. 1 is a perspective view showing a noise filter according to Embodiment 1 of the present invention.

FIG. 2 are an illustration diagram showing a configuration of the noise filter coil according to Embodiment 1 of the present invention.

FIG. 3 is a cross-sectional view of the noise filter according to Embodiment 1 of the present invention.

FIG. 4 is a perspective view showing a noise filter according to Embodiment 2 of the present invention.

FIG. 5 is a cross-sectional view of the noise filter according to Embodiment 2 of the present invention.

FIG. 6 is a cross-sectional view of a noise filter according to Embodiment 3 of the present invention.

FIG. 7 is a perspective view of a noise filter according to Embodiment 4 of the present invention.

FIG. 8 is a perspective view of a noise filter according to Embodiment 5 of the present invention.

FIG. 9 is a perspective view of a noise filter according to Embodiment 6 of the present invention.

FIG. 10 is a perspective view of a noise filter according to Embodiment 7 of the present invention.

### EMBODIMENTS FOR CARRYING OUT THE INVENTION

### Embodiment 1

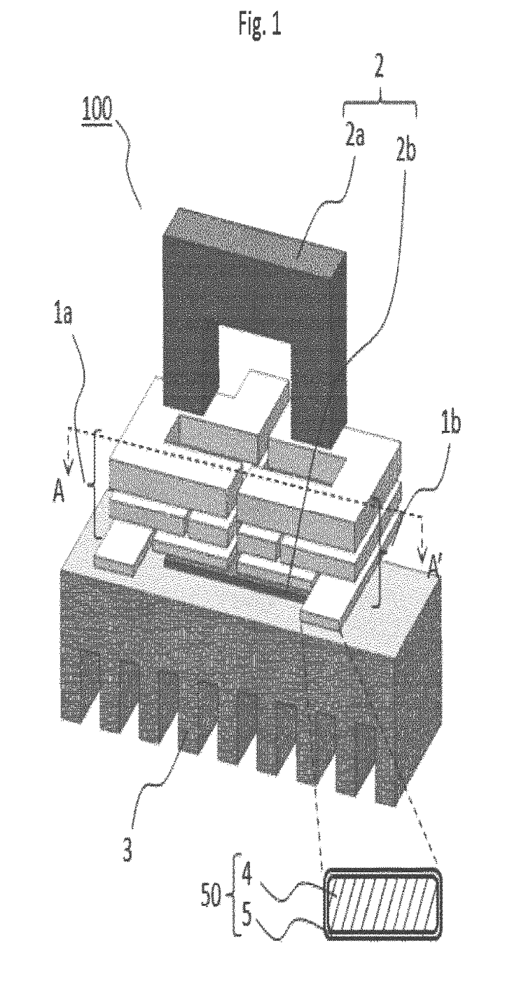

FIG. 1 is a perspective view of a noise filter according to Embodiment 1 of the present invention. A noise filter 100 in this embodiment is disposed, for example, between an inverter which is a power converter and a power supply to drive the inverter.

In FIG. 1, the noise filter 100 includes: a coil 1a and a coil 1b having winding patterns configured by stacking flat plate-shaped conductors 50; a magnetic core 2 around which the coils 1a and 1b are wound; and a heat dissipation member 3 electrically insulated from and closely attached to end portions of the coils 1a and 1b in the stacking direction of the coils. The electric potential of the heat dissipation member 3 is set to the ground potential.

The flat plate-shaped conductor 50 is an insulated conductor that is, for example, a metal flat plate 4 such as a copper plate with its outer face covered with a dielectric material 5. The dielectric material 5 is a coating material such as a polyimide, polyimide imide, and a polyester imide, or is a metal oxide formed by electrodeposition, or is an epoxy resin formed by powder coating, all of which preferably are materials with good heat dissipation. In addition, it is preferable, from the heat dissipation point of view, that the film thickness of the dielectric material 5 is as thin as possible within a range to ensure the insulation between the flat plate-shaped conductor 50 and the heat dissipation member 3, as well as the insulation between the stacked flat plate-shaped conductors 50.

In order to be inserted into the coils 1a and 1b, the magnetic core 2 is composed of a split core 2a with a U-shaped cross section and a split core 2b with a flat plate-shape; the split cores 2a and 2b are joined to form a closed magnetic circuit.

The heat dissipation member 3 is provided with heat dissipating fins. Note that although the flat plate-shaped conductors 50 composing the coils 1a and 1b are in actuality configured to be closely attached to each other, and also the magnetic core 2 is in actuality configured to be inserted into the coils 1a and 1b, they are depicted in FIG. 1 as separated to facilitate understanding of the noise filter configuration.

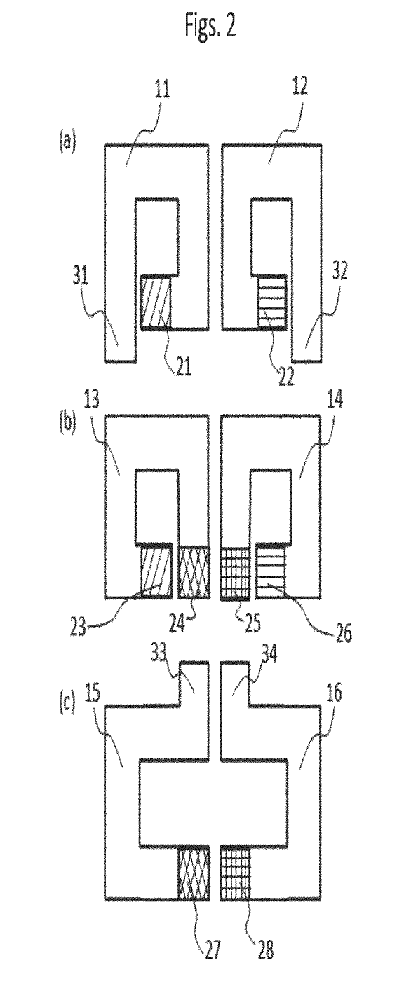

FIG. 2 are diagrams illustrating configurations of the coils 1a and 1b each of which is a stack of the flat plate-shaped conductors 50. In FIG. 2, FIGS. 2(a), 2(b) and 2(c) show respective flat plate-shaped conductors (winding pieces) to be stacked to form the coils 1a and 1b in FIG. 1. The left halves in FIGS. 2(a), 2(b) and 2(c) correspond to the coil 1a, and the right halves therein correspond to the coil 1b. Further, FIG. 2(a) shows conductors closely attached to the heat dissipation member 3; FIG. 2(b) shows the conductors stacked thereon; and FIG. 2(a) shows the conductors further stacked on the top of them. As shown in FIGS. 2, the coil 1a is composed of: a winding piece 11 as its bottom layer, a winding piece 13 stacked thereon, and a winding piece 15 stacked on the top. Also, the coil 1b is composed of: a winding piece 12 as its bottom layer, a winding piece 14 stacked thereon, and a winding piece 16 stacked on the top. In this embodiment, the winding pieces 11 to 16 have approximately equal widths in the current direction.

In FIG. 2, the winding pieces are electrically connected to each other to compose a coil with a spiral winding pattern. The outer faces of the metal flat plates 4 of the winding pieces are covered with the dielectric materials 5. For example, if the metal flat plates 4 are exposed at an end portion 21 of the upper face of the winding piece 11, at an end portion 23 of the lower face of the winding piece 13 as well as at an end portion 24 of the upper face thereof, and at an end portion 27 of the lower face of the winding piece 15, and when the winding pieces 11, 13 and 15 are stacked to be electrically connected through the portions where the metal flat plates are exposed, the spiral coil 1a can be formed. Similarly, if the metal flat plates 4 are exposed at an end portion 22 of the upper face of the winding piece 12, at an end portion 26 of the lower face of the winding piece 14 as well as at an end portion 25 of the upper face thereof, and at an end portion 28 of the lower face of the winding piece 16, and when the winding pieces 12, 14 and 16 are stacked to be electrically connected through the portions where the metal flat plates are exposed, the spiral coil 1b can be formed. Note that, as a method to connect them electrically, fusion bonding by using low melting-point metal, or mechanical bonding by using screws or rivets can be adopted. Also, in the coils 1a and 1b, coil terminal portions 31, 32, 33 and 34 are formed respectively on the winding pieces 11, 12, 15 and 16 in a protruding manner from the winding areas of the coils for electrically connecting with other devices. Note that it is preferable to make the junction areas of the portions connecting the winding patterns larger than the sectional areas of the flat conductors 4 in order to avoid local heat generation.

In this embodiment, the noise filter 100 is disposed, for example, between an inverter which is a power converter and a power supply to drive the inverter. In this case, the output terminals of the power supply are connected to the coil terminal portion 31 which is a terminal portion of the coil 1a, and the coil terminal portion 32 which is a terminal portion of the coil 1b. The input terminals of the inverter are connected to the coil terminal portion 33 which is another terminal portion of the coil 1a and the coil terminal portion 34 which is another terminal portion of the coil 1b. The noise filter 100 connected as described above can suppress propagation of the switching noise from the inverter to the power supply side and to the outside of the device. Note that, if the power supply voltage is low, a boost converter may be disposed between the noise filter and the inverter.

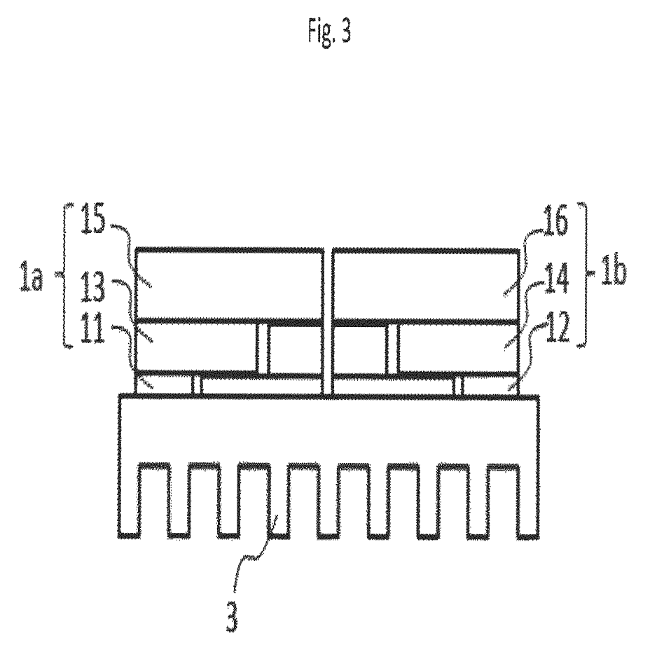

FIG. 3 is a cross-sectional view taken along the A-A′ line of the noise filter 100 according to this embodiment shown in FIG. 1. Winding pieces each composed of the flat plate-shaped conductor 50 are stacked on the heat dissipation member 3 to build the coils 1a and 1b. In this embodiment, the thicknesses of the winding pieces 11 and 12 in contact with the heat dissipation member 3 are made the thinnest compared with the thicknesses of the other winding pieces 13, 14, 15 and 16. In other words, the thicknesses of the winding pieces are configured such that the thermal resistances of the winding pieces 11 and 12 in contact with the heat dissipation member 3 are the smallest compared with the thermal resistances of the other winding pieces 13, 14, 15 and 16.

The thinner the conductor is, the smaller the sectional area for the current (I) to flow; this leads to a larger electric resistance (R). The thinner the conductor is, the more joule heat is generated because the joule heat generated by the current flowing in the conductor is in proportion to I²×R. Because the winding pieces 11 and 12 in contact with the heat dissipation member 3, however, are more efficient in heat dissipation compared with the other winding pieces, the winding pieces 11 and 12 can dissipate the heat to the heat dissipation member 3 more quickly than the other winding pieces. Further, the thinner conductors of the winding pieces in contact with the heat dissipation piece 3 can reduce the overall size of the coils 1a and 1b.

The metal flat plates 4 composing the conductors of the winding pieces 11 and 12 are in contact with the heat dissipation member 3 via the dielectric materials 5 to form stray capacitance between themselves and the heat dissipation member 3. By using this stray capacitance as a ground capacitor, the number of parts can be reduced from those of traditional noise filters configured by combining two individual parts of an inductor and a capacitor, thereby miniaturizing the noise filter. The amount of the stray capacitance can be adjusted to any amount by adjusting the film thickness of the dielectric material 5. Ideally, by making the dielectric film thinner as much as possible within the range to ensure the insulation between the flat plate-shaped conductors 50 and the heat dissipation member 3, the capacitance (ground capacitor) can be maximized, to improve the noise reduction effect and the heat dissipation performance.

If a noise filter is configured as described above, the heat dissipation of the noise filter can be improved without upsizing itself.

In this embodiment, only the winding pieces 11 and 12 in contact with the heat dissipation member 3 are made thinner than the other winding pieces. But, the thicknesses of the other winding pieces may also be adjusted appropriately. Taking the coil 1a as an example for explanation, the winding piece 11 in contact with the heat dissipation member 3 is made the thinnest, and the winding pieces 13 and 15 stacked on the winding piece 11 may be made thicker gradually from the thickness of the winding piece 11. With such configuration, the winding pieces distant from the heat dissipation member 3 have lower electric resistances to generate less joule heat, whereas the winding piece close to the heat dissipation member 3 generates some more joule heat, but has high heat dissipation characteristics to the heat dissipation member 3. Therefore, the rise of the overall temperature in the coil 1a can be suppressed.

It is preferable that the whole of the winding pieces 11 and 12 in contact with the heat dissipation member 3 be closely attached to the heat dissipation member 3. Therefore, it is preferable that the heat dissipation member 3 be provided with a cutout portion for embedding the split core 2b therein so that the level difference between the upper face of the split core 2b of the magnetic core 2 and the surface of the heat dissipation member 3 can be eliminated. In this embodiment, the magnetic core 2 is composed of the split core 2a with a U-shape cross section and the flat plate-shaped split core 2b. The split core 2b may also be shaped to have a U-shaped cross section.

### Embodiment 2

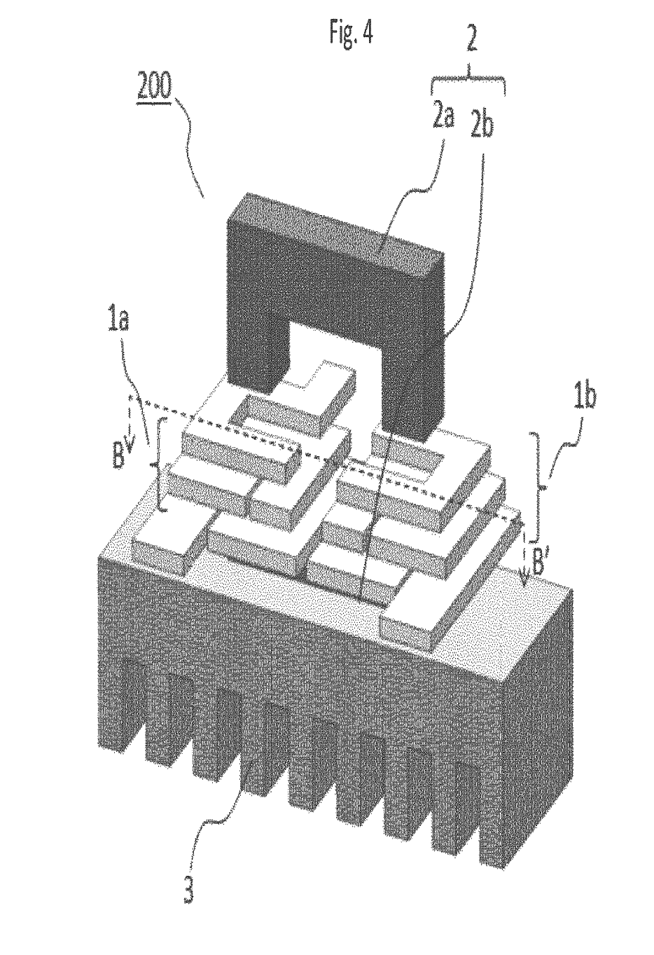

FIG. 4 is a perspective view of a noise filter according to Embodiment 2 of the present invention. The noise filter 200 according to this embodiment has the same components as described in Embodiment 1 and is different in coil shape when compared with the noise filter 100 described in Embodiment 1.

In FIG. 4, the noise filter 200 in this embodiment includes: a coil 1a and a coil 1b each having winding patterns configured by stacking flat plate-shaped conductors 50; a magnetic core 2 around which the coils 1a and 1b are wound; and a heat dissipation member 3 electrically insulated from and closely attached to end portions of the coils 1a and 1b in the stacking direction of the coils.

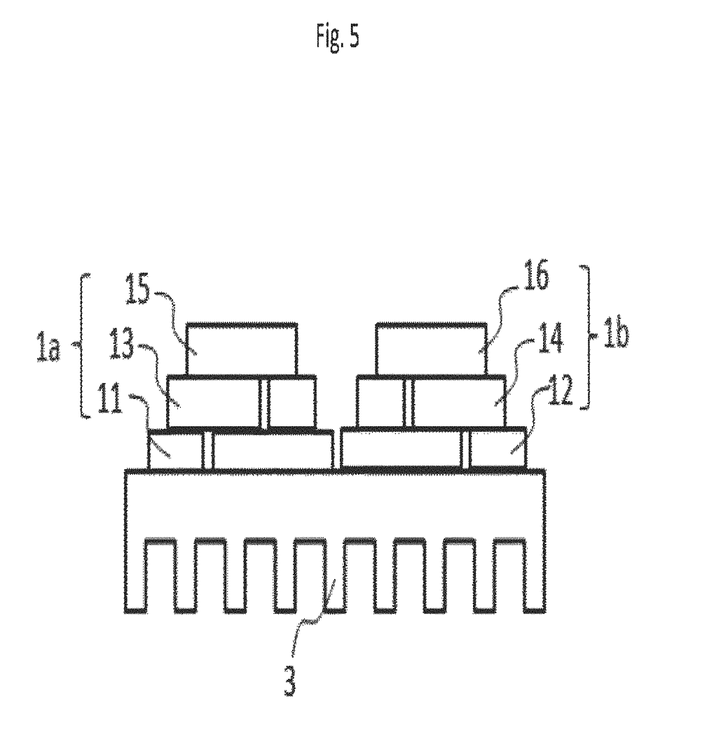

FIG. 5 is a cross-sectional view taken along the B-B′ line of the noise filter 200 according to this embodiment shown in FIG. 4. The coils 1a and 1b are configured such that winding pieces each composed of the flat plate-shaped conductor 50 are stacked on the heat dissipation member 3. In this embodiment, the widths of the conductors of the winding pieces 11 and 12 in contact with the heat dissipation member 3 are made the largest compared with the widths of the other conductors of the winding pieces 13, 14, 15 and 16. Note here that, in this embodiment, the thicknesses of the winding pieces 11 to 16 are made almost equal. As the result, each of the conductors of the winding pieces 11 and 12 in contact with the heat dissipation member 3 has the largest area in section facing in the stacking direction, when compared with the conductors of the other winding pieces 13, 14, 15 and 16. Namely, the thermal resistance of the winding pieces 11 and 12 in contact with the heat dissipation member 3 is made the smallest compared with the thermal resistances of the other winding pieces 13, 14, 15 and 16.

The larger the area in section facing in the stacking direction the conductor has, the larger the contact area with the heat dissipation member 3 will be, which can improve heat dissipation of the coils 1a and 1b. By improving the heat dissipation of the coils 1a and 1b, each winding piece can be made thinner. As the result, although the sizes of the coils 1a and 1b in the lateral direction become larger, the overall sizes of the coils 1a and 1b can be miniaturized because the thicknesses of the winding pieces can be thinner.

Further, the increase in the area in contact with the heat dissipation member 3 can increase the capacitance between the metal flat plates 4 and the heat dissipation member 3, which can improve the noise reduction affect.

A noise filter with this configuration can improve the heat dissipation without upsizing itself.

Note that in this embodiment, each of the winding pieces 11 and 12 in contact with the heat dissipation member 3 has a larger area in section facing in the stacking direction when compared with the other winding pieces; the areas that the other winding pieces have in section facing in the stacking direction, however, may be adjusted appropriately. In the coil 1a shown as an example in FIG. 5, in comparison with the area in section facing in the stacking direction of the winding piece 15 distant from the heat dissipation member 3, the winding pieces 13 and 11 disposed closer to the heat dissipation member 3 may have gradually larger areas in section facing in the stacking direction. With such configuration, the heat dissipation characteristics to dissipate from the winding piece close to the heat dissipation member 3 to the heat dissipation member 3 can be improved. By improving the heat dissipation of the coils 1a and 1b, the conductor of the each winding piece can be made still thinner, which can further miniaturize the whole of the coils 1a and 1b.

In this embodiment, it is assumed that the thicknesses of the stacked winding pieces are all equal. Similarly to the Embodiment 1, however, the conductor of the winding pieces in contact with the heat dissipation member 3 may be made thinner than the conductors of the other winding pieces in order to miniaturize the noise filter 200.

### Embodiment 3

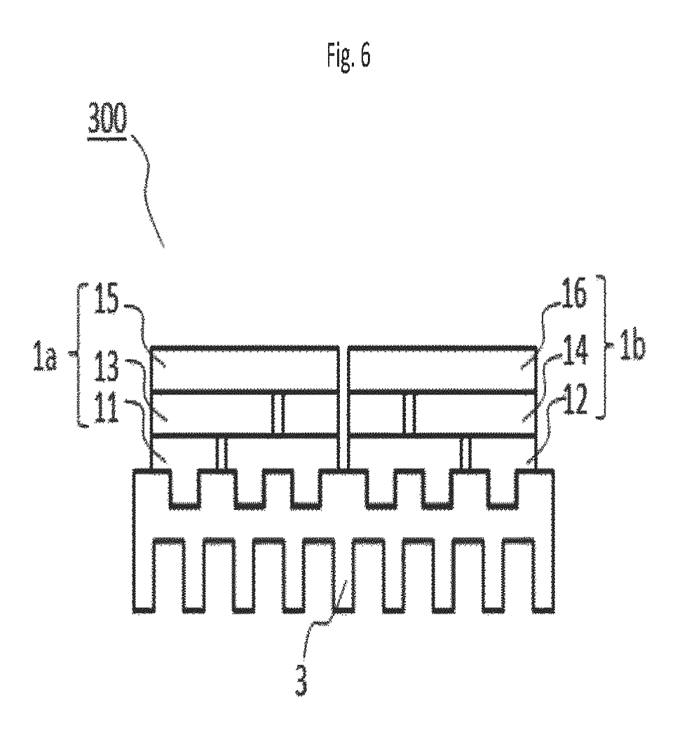

FIG. 6 is a cross-sectional view of a noise filter 300 in Embodiment 3. The noise filter 300 according to this embodiment has the same components as the noise filter 100 described in Embodiment 1; however, the heat dissipation member 3 and the winding pieces in contact with the heat dissipation member 3 have shapes different from those of Embodiment 1.

In FIG. 6, the noise filter 300 in this embodiment includes: a coil 1a and a coil 1b having winding patterns configured by stacking fiat plate-shaped conductors 50; a magnetic core (not shown) around which the coils 1a and 1b are wound; and a heat dissipation member 3 electrically insulated from and closely attached to end portions of the coil 1a and 1b in the stacking direction of the coils.

The coils 1a and 1b are configured such that the winding pieces each composed of the flat plate-shaped conductor 50 are stacked on the heat dissipation member 3. In this embodiment, the opposing faces, namely the faces of the conductors of the winding pieces 11 and 12 in contact with the heat dissipation member 3 and the face of the heat dissipation member 3, are formed in uneven shapes so as to be closely attached to each other.

The uneven shapes, with which the conductors of the winding pieces 11 and 12 and the heat dissipation member 3 are closely attached to each other, may have cylindrical unevenness, rectangular unevenness, slit-shaped unevenness or the like.

The noise filter with this configuration has larger contact areas between the conductor of the winding piece 11 and the heat dissipation member 3 as well as between the conductor of the winding piece 12 and the heat dissipation member 3, which can improve heat dissipation in the coils 1a and 1b. The improved heat dissipation in the coils 1a and 1b allows the conductor thickness of each winding piece to be configured thinner, which can miniaturize the whole of the coils 1a and 1b.

Also the increased contact areas with the heat dissipation member 3 increase capacitance between the metal fiat plates 4 and the heat dissipation member 3, which can improve the noise reduction effect.

The noise filter with this configuration can improve the heat dissipation without upsizing itself.

### Embodiment 4

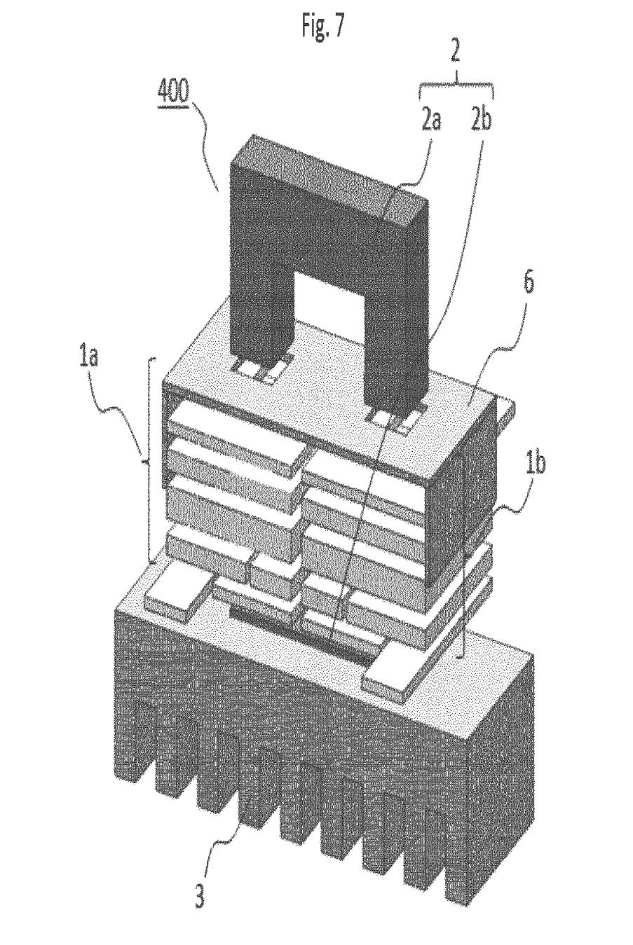

FIG. 7 is a perspective view of a noise filter according to Embodiment 4. The noise filter 400 in this embodiment has the same components as the noise filter 100 described in Embodiment 1, but further includes a cooling member which is electrically insulated from and closely attached to coil end portions of the coils, the other end portions of which are closely attached to the heat dissipation member.

In FIG. 7, the noise filter 400 includes: a coil 1a and a coil 1b having winding patterns configured by stacking flat plate-shaped conductors; a magnetic core 2 around which the coils 1a and 1b are wound; a heat: dissipation member 3 electrically insulated from and closely attached to end portions of the coils 1a and 1b in the stacking direction of the coils and a cooling member 6 electrically insulated from and closely attached to coil end portions of the coils 1a and 1b, the other end portions of which are closely attached to the heat dissipation member. A metal plate, for example, can be used for the cooling member 6. The coils 1a and 1b are configured such that winding pieces each composed of the flat plate-shaped conductor are stacked on the heat dissipation member 3. Further, in this embodiment, the winding pieces in contact with the heat dissipation member 3 and the winding pieces in contact with the cooling member 6 are configured to be thinner than the other winding pieces in the middle of the coils.

The noise filter with this configuration can dissipate the heat in the coils 1a and 1b through both the heat dissipation member 3 and the cooling member 6, which can improve heat dissipation of the noise filter without capsizing itself. Also the improved efficiency in cooling the coils 1a and 1b allows the conductors of the coils 1a and 1b to be thinner, which can further miniaturize the noise filter.

In this embodiment, the electric potential of the cooling member 6 may be set to the ground potential, similarly to that of the heat dissipation member 3. For example, the cooling member 6 and the heat dissipation member 3 may be configured to be electrically connected. With this configuration, the metal flat plates of the coils 1a and 1b are to be in contact with the cooling member 6 and the heat dissipation member 3 via dielectric materials, and as the result, stray capacitance is formed between the metal flat plates of the coils 1a and 1b and the cooling member 6, as well as between the metal flat plates and the heat dissipation member 3. By using the stray capacitance as a ground capacitor, the capacitance of the noise filter 400 can be increased, which can improve the noise reduction effect.

The coil configurations described in Embodiments 2 and 3 can be combined with the noise filter shown in this embodiment.

### Embodiment 5

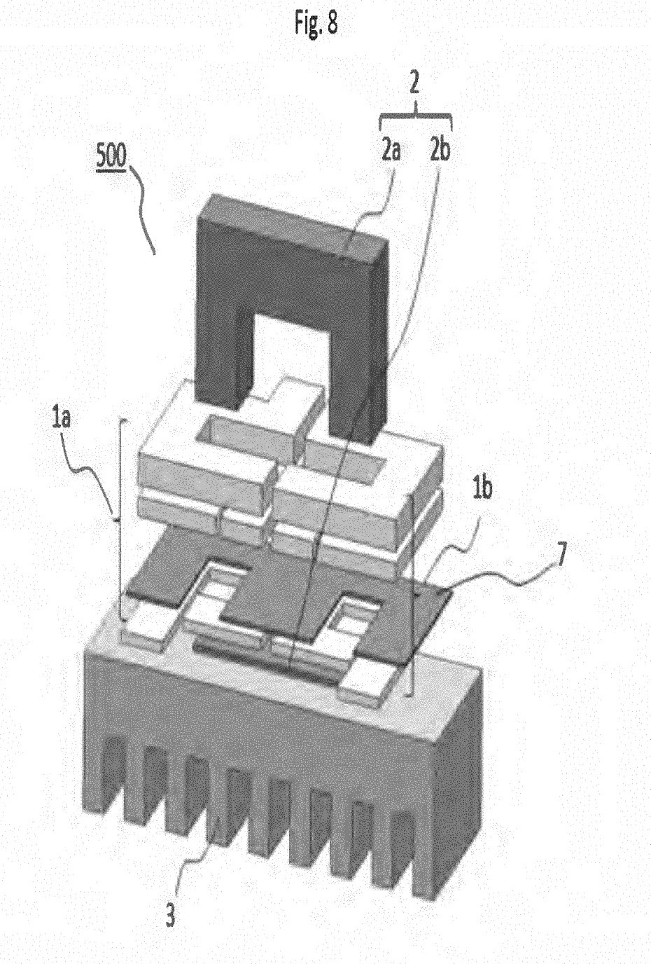

FIG. 8 is a perspective view of a noise filter according to Embodiment 5. The noise filter 500 in this embodiment has the same components as the noise filter 100 described Embodiment 1, but further includes a conductive plate which is arranged between the layers of the stacked flat plate-shaped conductors and which is electrically insulated from and closely attached to the conductors, and electrically connected to the heat dissipation member.

In FIG. 8, the noise filter 500 includes: a coil 1a and a coil 1b having winding patterns configured by stacking the same flat plate-shaped conductors as shown in Embodiment 1; a magnetic core 2 around which the coils 1a and 1b are wound; a heat dissipation member 3 electrically insulated from and closely attached to ends of the coils 1a and 1b in the stacking direction of the coils; and a conductive plate 7 inserted so as to be on the reverse faces of the flat plate-shaped conductors having faces closely attached to the heat dissipation member. The conductive plate 7 is arranged between the layers of the conductors composing the coils 1a and 1b, electrically insulated from and closely attached to the conductors, and also is electrically connected to the heat dissipation member. A metal plate, for example, can be used for the conductive plate 7.

In the noise filter with this configuration, the winding pieces in contact with the heat dissipation member 3 are configured to be the thinnest compared with the other winding pieces, which can improve heat dissipation of the noise filter without capsizing itself.

Further, in addition to the stray capacitance formed between the coil 1a and the heat dissipation member 3 as well as between the coil 1b and the heat dissipation member, the stray capacitance formed between the coil 1a and the conductive plate 7 as well as between the coil 1b and the conductive plate can be used as a ground capacitor, which can increase the capacitance of the noise filter 500, to improve noise reduction effect; thereof.

In this embodiment, the conductive plate 7 is disposed on the reverse faces of the flat plate-shaped conductors having the faces closely attached to the heat dissipation member. The conductive plate, however, can be disposed between any layers of the stacked flat plate-shaped conductors.

### Embodiment 6

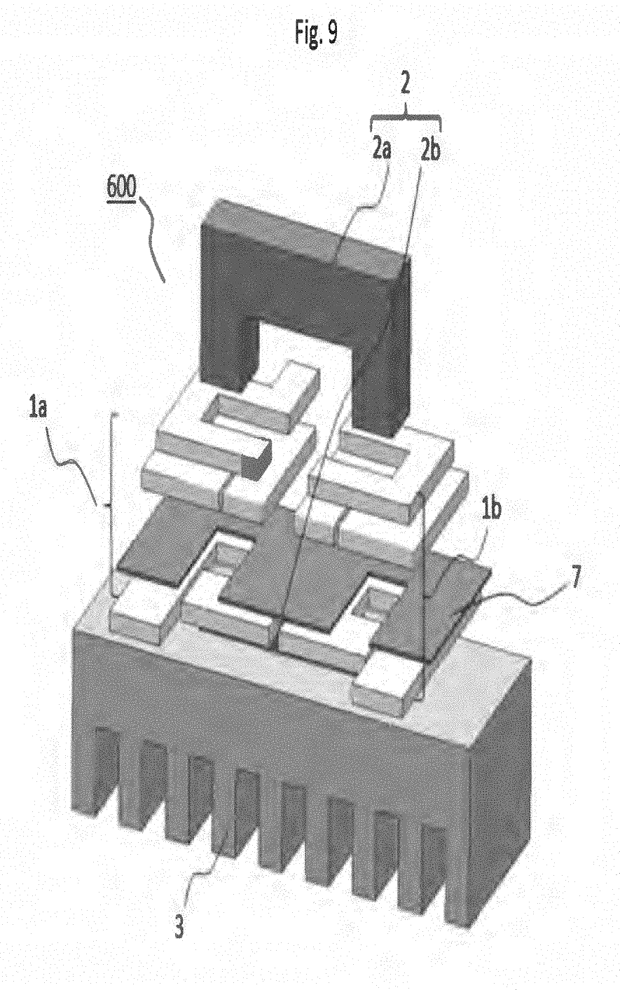

FIG. 9 is a perspective view of a noise filter according to Embodiment 6. The noise filter 600 in this embodiment is a combination of the conductive plate 7 described in Embodiment 5 with the noise filter described in Embodiment 2.

In FIG. 9, the noise filter 600 includes: a coil 1a and a coil 1b having winding patterns configured by stacking the same flat plate-shaped conductors as shown in Embodiment 2; a magnetic core 2 around which the coils 1a and 1b are wound; a heat dissipation member 3 electrically insulated from and closely attached to end portions of coils 1a and 1b in the stacking direction of the coils; and a conductive plate 7 inserted so as to be on the reverse faces of the flat plate-shaped conductors having faces closely attached to the heat dissipation member. The conductive plate 7 is arranged between the layers of the conductors composing the coils 1a and 1b, electrically insulated from and closely attached to the conductors, and also is electrically connected to the heat dissipation member.

In the noise filter with this configuration, the winding pieces in contact with the heat dissipation member 3 are configured to each have the largest area in section facing in the stacking direction compared with the other winding pieces, which can improve heat dissipation of the noise filter without upsizing itself.

Further, in addition to the stray capacitance formed between the coil 1a and the heat dissipation member 3 as well as between the coil 1b and the heat dissipation member, the stray capacitance formed between the coil 1a and the conductive plate 7 as well as between the coil 1b and the conductive plate can be used as a ground capacitor, which can increase the capacitance of the noise filter 600 to improve the noise reduction effect thereof.

In this embodiment, the conductive plate 7 is disposed on the reverse faces of the flat plate-shaped conductors having the faces closely attached to the heat dissipation member. The conductive plate, however, can be disposed between any layers of the stacked flat plate-shaped conductors.

### Embodiment 7

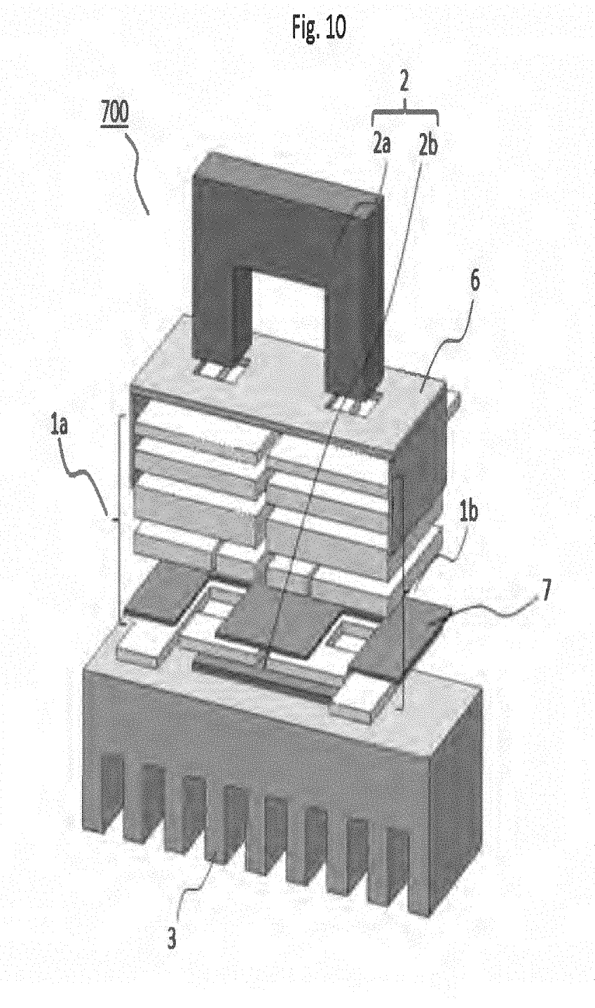

FIG. 10 is a perspective view of a noise filter according to Embodiment 7. The noise filter 700 in this embodiment is a combination of the conductive plate 7 described in Embodiment 5 with the noise filter described in Embodiment 4.

In FIG. 10, the noise filter 700 includes: a coil 1a and a coil 1b having winding patterns configured by stacking the same flat plate-shaped conductors as shown in Embodiment 4; a magnetic core 2 around which the coils 1a and 1b are wound; a heat dissipation member 3 electrically insulated from and closely attached to end portions of the coils 1a and 1b in the stacking direction of the coils; a cooling member 6 electrically insulated from and closely attached to coil end portions of the coils 1a and 1b, the other end portions of which are closely attached to the heat: dissipation member; and a conductive plate 7 inserted so as to be on the reverse faces of the flat plate-shaped conductors having faces closely attached to the heat dissipation member. The conductive plate 7 is arranged between the layers of the conductors composing the coils 1a and 1b, electrically insulated from and closely attached to the conductors, and also is electrically connected to the heat dissipation member.

The noise filter with this configuration can dissipate the heat in the coils 1a and 1b through both the heat dissipation member 3 and the cooling member 6, to thereby improve heat dissipation of the noise filter without upsizing itself.

Further, in addition to the stray capacitance formed between the coil 1a and the heat dissipation member 3 as well as between the coil 1b and the heat dissipation member, the stray capacitance formed between the coil 1a and the conductive plate 7 as well as between the coil 1b and the conductive plate can be used as a ground capacitor, which can increase the capacitance of the noise filter 700 to improve the noise reduction effect thereof.

In this embodiment, the conductive plate 7 is disposed on the reverse faces of the flat plate-shaped conductors having the faces closely attached to the heat dissipation member. The conductive plate, however, can be disposed between any layers of the stacked flat plate-shaped conductors.

In Embodiments 5 to 7, explanation has been made on examples in which the conductive plate 7 is combined with the configurations of the noise filters described in Embodiments 1 to 3. Also, the conductive plate 7 may be combined with the configuration of the noise filter described in Embodiment 4.

In Embodiments 1 to 7, while the conductors composing the coils 1a and 1b are each assumed to be a metal flat-plate conductor with its outside covered by a dielectric material, the conductor may be of a different kind. For example, a metal flat plate sealed with an embedding resin, or a conductor molded and integrated into a printed board may be used. Also, a configuration may be adopted in which metal flat plates are used as the conductors and dielectric sheets are disposed between the conductors between which insulation should be ensured. In a case where the coils 1a and 1b are used under de voltage, if the conductors' sectional areas are large enough, the electric potential differences between layers of winding pieces are 1 volt or less, which means that the insulation is sufficiently ensured by gas or air. In that case, the insulation can be ensured, not by a dielectric material, but by separating conductors to use air layers therebetween. With air having a relative permittivity smaller than a solid dielectric material, the conductors' interlayer capacitance can be reduced. As the result, the noise currents flowing between the layers can be suppressed, to thereby improve the noise reduction effect of the noise filter.

Further, in order to insulate between the coil 1a and the heat dissipation member 3 as well as between the coil 1b and the heat dissipation member, and between the coil 1a and the cooling member 6 as well as between the coil 1b and the cooling member, insulating members may be inserted therebetween. For the insulating members, a material with high thermal conductivity and high relative permittivity is preferable. For example, a material such as a ceramic substrate, a high heat dissipation insulating sheet filled with inorganic filler, or heat dissipation grease can be used.

### DESCRIPTION OF SYMBOLS

100, 200, 300, 400, 500, 600, 700: noise filter
1a, 1b: coil
2: magnetic core
2a, 2b: split core
3: heat dissipation member
4: metal flat plate
5: dielectric material
6: cooling member
7: conductive plate
11 to 16: winding piece
21 to 28: connection portion
31 to 34: terminal portion
50: conductor

1-8. (canceled)

9. A noise filter comprising:
a coil having a winding pattern configured by stacking flat plate-shaped conductors;
a magnetic core around which the coil is wound; and
a heat dissipation member electrically insulated from and closely attached to an end of the coil in a stacking direction,
wherein a thermal resistance of one of the conductors, disposed at the end in the stacking direction, is the lowest compared with thermal resistances of the other conductors.

10. The noise filter according to claim 9, wherein the conductor disposed at the end in the stacking direction is the thinnest compared with the other conductors.

11. The noise filter according to claim 9, wherein the conductor disposed at the end in the stacking direction has the largest area in section facing in the stacking direction, in comparison with the other conductors' areas in section facing in the stacking direction.

12. The noise filter according to claim 10, wherein the conductor disposed at the end in the stacking direction has the largest area in section facing in the stacking direction, in comparison with the other conductors areas in section facing in the stacking direction.

13. The noise filter according to claim 9, wherein faces with which the conductor disposed at the ea d in the stacking direction and the heat dissipation member are closely attached have uneven shapes to fit each other.

14. The noise filter according to claim 10, wherein faces with which the conductor disposed at the end in the stacking direction and the heat dissipation member are closely attached have uneven shapes to fit each other.

15. The noise filter according to claim 11, wherein faces with which the conductor disposed at the end in the stacking direction and the heat dissipation member are closely attached have uneven shapes to fit each other.

16. The noise filter according to claim 9, further comprising a cooling, n ember electrically insulated from and closely attached to an opposite end of the coil with respect to the end thereof closely attached to the heat dissipation member.

17. The noise filter according to claim 10, further comprising a cooling member electrically insulated from and closely attached to an opposite end of the coil with respect to the end thereof closely attached to the heat dissipation member.

18. The noise filter according to claim 11, further comprising a cooling member electrically insulated from and closely attached to an opposite end of the coil with, respect to the end thereof closely attached to the heat dissipation member.

19. The noise filter according to claim 13, further comprising a cooling member electrically insulated from and closely attached to an opposite end of the coil with respect to the end thereof closely attached to the heat dissipation member.

20. The noise filter according to claim 9, further comprising a dielectric material between the coil and the heat dissipation member.

21. The noise filter according to claim 10, further comprising a dielectric material between the Coil and the heat dissipation member.

22. The noise filter according to claim 11, further comprising a dielectric material between the coil and the heat dissipation member.

23. The noise filter according to claim 13, further comprising a dielectric material between the coil and the heat dissipation member.

24. The noise filter according to claim 16, further comprising a dielectric material between the coil and the cooling member.

25. The noise filter according to claim 9, further comprising a conductive plate between layers of two of the conductors constituting the coil, the conductive plate electrically insulated from and closely attached to the two conductors, and electrically connected to the heat dissipation member.

26. The noise filter according to claim 10, further comprising a conductive plate between layers of two of the conductors constituting the coil, the conductive plate electrically insulated from and closely attached to the two conductors, and electrically connected to the heat dissipation member.

27. The noise filter according to claim 11, further comprising a conductive plate between layers of two of the conductors constituting the coil, the conductive plate electrically insulated from and closely attached to the two conductors, and electrically connected to the heat dissipation member.

28. The noise filter according to claim 13, further comprising a conductive plate between layers of two of the conductors constituting the coil, the conductive plate electrically insulated from and closely attached to the two conductors, and electrically connected to the heat dissipation member.
